(19) United States
(12) Patent Application Publication
(10) Pub. No.: US 2013/0001448 A1
(43) Pub. Date: Jan. 3, 2013

(54) Processes Utilizing Switch Condensers

(75) Inventors: Nicolaas A De Munck, Barendrecht (NL); George F.H. Grootens, Dirksland (NL)

(73) Assignee: EXXONMOBIL CHEMICAL PATENTS INC., Houston, TX (US)

(21) Appl. No.: 13/574,551

(22) PCT Filed: Jan. 11, 2011
(86) PCT No.: PCT/US2011/020781

§ 371 Date: Sep. 10, 2012

Related U.S. Application Data
(60) Provisional application No. 61/304,063, filed on Feb. 12, 2010.

(30) Foreign Application Priority Data
Apr. 23, 2010 (EP) 10160912.1

(51) Int. Cl. F16K 31/02

(52) U.S. Cl. 251/129.01

(57) ABSTRACT

Processes for controlling the operation of switch condensers are provided.

### PRIORITY CLAIM

This application claims the benefit of Ser. No. 61/304,063, filed Feb. 12, 2010, and EP 10160912.1, filed Apr. 23, 2010, the disclosures of which are incorporated by reference in their entireties.

### FIELD OF THE INVENTION

Embodiments disclosed herein generally relate to processes utilizing switch condensers in the recovery of, for example, phthalic anhydride.

### BACKGROUND OF THE INVENTION

Phthalic anhydride (PAN) is an important commercial chemical useful in the manufacture of plasticizers, polyesters, alkyd resins, and dyes. One important use is in the production of alkyl phthalates such as di-isononyl or di-isodecyl phthalates which are used as plasticizers typically for polyvinyl chloride. These phthalates may be further hydrogenated to the corresponding di-cyclohexanoates. Phthalic anhydride is typically produced from raw materials such as orthoxylene (o-xylene) and naphthalene, suitable oxidation processes are disclosed in WO 2009/040245 and WO 2009/040246. The price of these raw materials and, as a direct result, the price of phthalic anhydride, has fluctuated greatly depending upon supply and demand. Because the cost of the raw materials is a major factor in the price of phthalic anhydride, it is of great importance that any system used to produce phthalic anhydride capture as much of the resultant product as possible. Phthalic anhydride may be successfully produced from any of a number of processes, i.e., (1) air oxidation of o-xylene in fixed-bed reactors; (2) air oxidation of petroleum or coal tar naphthalene in fixed-bed reactors; (3) fluid bed oxidation of o-xylene; (4) fluid bed oxidation of petroleum or coal tar naphthalene; and (5) liquid phase oxidation of o-xylene or naphthalene.

The general process scheme for the various vapor phase routes is to mix the hydrocarbon feed (in the vapor form) with compressed air and to feed the mixture to multi-tubular fixed-bed reactors which contain tubes packed with oxidation catalysts, e.g., vanadium oxide and titanium dioxide coated on an inert, nonporous carrier. When fluid bed reactors are used, the hydrocarbon feed in liquid form can be injected directly into the fluidized catalyst bed so that the air and the hydrocarbon are mixed in the reactor to produce a reactor effluent gas (i.e., the vapor phase oxidation product). The reactors are equipped with means for removing the heat of the oxidation reaction. The heat that is removed is used to generate steam.

After the vapor phase oxidation product exits either the fixed-bed or fluid bed reactors, it is cooled to cause the phthalic anhydride to condense. This allows separation of the phthalic anhydride from the gas stream.

In the production of phthalic anhydride, the reaction product exiting the multi-tubular fixed-bed or fluid-bed reactor containing the oxidation catalyst is a hot gas mixture containing amongst others nitrogen, water, CO₂, and the desired phthalic anhydride. The reaction product is typically first cooled in a gas cooler, whereby most conveniently steam may be generated on the coolant side. The phthalic anhydride is usually recovered from the cooled reaction product by (de)sublimation in a switch condenser, a phase change that also may be called condensation or deposition, whereby the phthalic anhydride is collected as a solid on the switch condenser surface, usually the heat exchanger tubes, which are typically finned on the gas side to improve the heat transfer. The switch condenser is cooled with a cooling fluid, typically a thermal fluid or hot oil, capable of withstanding the high temperatures that are employed. After having been in collecting service, building up a layer of solid phthalic anhydride, typically on the outer surface of the finned exchanger tubes, the switch condenser may be switched from collecting service to melting service. Hereby the gas flow through the switch condenser is usually discontinued and typically the cooling fluid is replaced by a heating fluid, usually the same thermal fluid or hot oil but now after heating, such that the phthalic anhydride melts and forms a liquid, and the liquid phthalic anhydride is drained and collected for further processing. The emptied switch condenser is cooled before putting it back into collecting service by replacing the heating fluid by the cooling fluid.

The phthalic anhydride is typically condensed as a solid. However, a two-stage condensation system may be used to first condense a portion of the phthalic anhydride as a liquid and then to condense the remainder as a solid. The process further comprises recovering phthalic anhydride from the reaction product mixture by a precondenser condensing phthalic anhydride as a liquid followed by a switch condenser collecting phthalic anhydride as a solid. The addition of a precondenser provides the advantage that the gaseous mixture is brought outside the explosive limits by reducing the concentration of the explosive components and by lowering the operating temperature to below the minimum ignition temperature for the resulting gaseous mixture, and this before the gas mixture enters the switch condensers. The precondenser preferably also contains finned tubes, and may be cooled with any type of cooling medium, for example, hot water may be used as it allows avoiding the occurrence of spots having too low temperatures and having the ability to control the precondenser outlet temperature within a narrow range. The outlet of the precondenser may be kept at a temperature of at least 137° C.

The use of switch condensers to separate crude phthalic anhydride from a vapor phase oxidation product is described in, for example, U.S. Pat. Nos. 4,435,580, 5,214,157, 5,508,443, and 5,869,700. The resultant vapor phase oxidation product is stepwise cooled from the reaction temperature through one or more gas coolers to 170-180° C. before entering the switch condensers or optionally the precondenser in which it is further cooled to at least 137° C. The switch condenser inlet temperature should be sufficiently high to prevent condensation of liquid phthalic anhydride or the deposition of solid phthalic anhydride and phthalic acid at zones with a low wall temperature by operating not too close to the solidification point (131° C.) of phthalic anhydride. Any condensed liquid is usually separated out before the remaining vapor enters the switch condensers. The switch condensers desublime the vapor phase oxidation product using the cold condenser oil, and then melt off the solid phase crude phthalic anhydride product using hot condenser oil heated with steam. Both the hot condenser oil and cold condenser oil are pumped through a multiple valve and piping arrangement into the switch condensers equipped with horizontally disposed finned heat exchanger tubes as disclosed in DE 44 27 872.

In this process and after a certain period of time, the switch condenser is filled with product and the condenser is then switched into the heating mode to melt the PAN for further purification. Upon completion of the melt step the condenser is cooled to prepare it for the next desublimation cycle. In the PAN production process at least two switch condensers are required to enable an uninterrupted flow through the oxidation reactor. In practice three or more switch condensers may be used depending on the capacity of the oxidation reactor and the surface area of the individual switch condenser. The number and surface area of the switch condensers is also related to the total gas rate through the oxidation reactor and the switch condenser section as too high velocities will cause a reduced efficiency of the switch condenser by a too a short residence time in the switch condenser and by carryover of condensed PAN solids into downstream waste gas cleanup equipment. Although large surface areas are preferred to lower the velocities through the switch condensers the total number of switch condensers will be limited to optimize the investment for the PAN production facility. Examples have been reported with three 6000 m², twelve 4200 m² or seven 2550 m² switch condensers depending upon the total capacity of the PAN production facility.

For the seven switch condenser configuration, normally, 5 condensers are in desublimation mode, one of them in the melting mode, and another one is in the cooling mode. This is generally referred to as the 5/2 cycle. For the three switch condenser configuration, normally, 2 condensers are in desublimation mode and one of them is in the combined melting and cooling mode. For the 12 switch condenser configuration, normally, up to 10 condensers are in desublimation mode, 1 or more of them are in the melting mode, and another 1 or 2 are in the cooling mode. In advanced systems, a process control system, for example, including a process control application automatically controls the various operating modes and the switching steps for the switch condenser process gas inlet and outlet valves and for the cooling and heating liquid inlet and outlet valves. The process control system provides for a continuous check of the condition of the switching valves to protect the downstream waste gas cleanup equipment such as a catalytic incinerator for uncontrolled carryover of valuable PAN. The application also allows to change the temperature of the cooling and heating medium more gradually to minimize thermal stress on the switch condenser equipment. The thermal stress causes mechanical failures resulting into leakage of the PAN product, contamination of PAN product by internal leakage of oil into the PAN requiring immediate interruption of the service but which also shortens the useful life of the switch condenser. In other areas, applications have been proposed. See, for example, US Patent Application Publication No. 2009/0005908 and EP 2 009 520 A.

Other background references include DE 35 12 930, GB 916 882, and U.S. Pat. No. 4,391,617.

In case of failure of one of the switch condensers, associated instrumentation or equipment the PAN production unit has to be shutdown, the failed switch condenser has to be bypassed and upon restart of the remaining six condensers to operate in a 4/2 cycle mode. This mode is very uneconomical due to the production loss resulting from the facility downtime and the loss of typically 20% exchanger capacity. This causes a 25% higher gas rate through the switch condensers reducing its efficiency and causing a higher organic load on the downstream catalytic incinerator. It also increases the risk of failure of the incinerator catalyst. An alternative would be to reduce the gas rate through the oxidation reactor by 20% to compensate for the loss of exchanger capacity, which causes a corresponding loss in production capacity. Thus, it would be desirable to avoid, minimize, or defer a facility shutdown, while retaining the efficiency of the switch condensers. Additionally, it would also be desirable to better protect downstream equipment such as the catalytic incinerator against overloading and failure.

### SUMMARY OF THE INVENTION

In a class of embodiments, the invention provides for a continuous process for controlling a plurality of switch condensers, the process comprising:

operating a plurality of switch condensers in an x/y cycle;

detecting at least one change in the plurality of the switch condensers; and

switching the plurality of switch condensers to an x/y−n cycle;

wherein x is the number of switch condensers in the desublimation mode; y is the number of switch condensers in the melting mode and cooling mode; x+y is the sum of the total number of switch condensers; and n is independently a number from 1-20.

In the previous embodiment, n is a number from 1-15 or 1-10.

In the previous embodiments, the process may further comprise switching the plurality of switch condensers to operate in an x+n′/y−n cycle; wherein n′ is independently a number from 1-20.

In the previous embodiments, the process may further comprise switching the plurality of switch condensers to operate in an x+n″/y−n cycle; wherein n″ is independently a number from 1-20.

In another class of embodiments, the invention also provides for a continuous process for the recovery of phthalic anhydride, the process comprising:
producing phthalic anhydride;
passing the phthalic anhydride through a plurality of switch condensers operating in a 5/2 cycle;
detecting at least one change in a phthalic anhydride recovery process parameter; and
switching the plurality of switch condensers to operate in a 5/1 cycle.

The previous embodiment may further comprise switching the plurality of switch condensers to operate in a 4/1 cycle.

In any of the embodiments described herein, the switching may be controlled by a process control application.

In the previous embodiment, the process control application may comprise a distributed control software program.

In the previous embodiments, the process control application may comprise at least one of the abilities to control the operating modes, to monitor the condition of the switching valves, to regulate the temperature of the switch condensers, and any combination thereof.

In any of the embodiments described herein, after the switching, the gas rate through the switch condensers may remain substantially the same.

In any of the embodiments described herein, after the switching, the gas rate through the switch condensers may be increased by no more than 10%.

In any of the embodiments described herein, after the switching, the gas rate through the switch condensers may be increased by no more than 5%.

In any of the embodiments described herein, the loss of heat exchanger capacity of the plurality of the switch condensers after switching cycles may be 15% or less.

In any of the embodiments described herein, the loss of heat exchanger capacity of the plurality of the switch condensers after switching cycles may be 10% or less.

In any of the embodiments described herein, the loss of heat exchanger capacity of the plurality of the switch condensers after switching cycles may be 5% or less.

### BRIEF DESCRIPTION OF THE DRAWINGS

FIG. 1 shows a typical general layout of a switch condenser section with one common inlet and outlet header.

FIG. 2 shows a typical general layout of a switch condenser section with one common inlet header and two parallel outlet sub-headers combining into an outlet header.

FIG. 3 shows an example of a switch condenser in the desublimation mode recovering the phthalic anhydride from the gas stream.

FIG. 4 shows an example of a switch condenser in the melting mode to remove the phthalic anhydride from the switch condenser.

FIG. 5 shows an example of a switch condenser in the cooling mode to prepare for the desublimation mode.

### DETAILED DESCRIPTION

Before the present compounds, components, compositions, devices, softwares, hardwares, equipments, configurations, schematics, systems, and/or methods are disclosed and described, it is to be understood that unless otherwise indicated this invention is not limited to specific compounds, components, compositions, devices, softwares, hardwares, equipments, configurations, schematics, systems, methods, or the like, as such may vary, unless otherwise specified. It is also to be understood that the terminology used herein is for the purpose of describing particular embodiments only and is not intended to be limiting.

It must also be noted that, as used in the specification and the appended claims, the singular forms “a,” “an” and “the” include plural referents unless otherwise specified.

At least one change in a phthalic anhydride recovery process parameter refers to any event that would shut down or reduce the efficiency of the recovery process of phthalic anhydride utilizing a plurality of switch condensers. For example, the event may include the failure of at least one switch condensers in the plurality of switch condensers. Failure may include, for example, an internal leakage of heat transfer oil from the heat exchanger bundle into the process, an external leakage of heat transfer oil, and an external leakage of phthalic anhydride. In these cases, a potential problem may develop requiring the shut-down of the switch condenser on a planned or emergency basis. A reduction of the efficiency of the recovery process may be related to the loss of heat exchanger capacity, which becomes visible by an increased process off-gas outlet temperature, or a reduced cooling oil outlet temperature, or a reduction of the drained molten PAN during the melting mode, or by a larger temperature increase in the downstream thermal or catalytic incinerator. Other examples of failure may be the development of pressure drop inside the switch condenser or in the piping to or from the switch condenser. By the increased pressure drop of the particular switch condenser, the other parallel switch condensers may receive additional gas flow which reduces the efficiency of the condensers and of the unit as a whole. Failure may also relate to the inlet and outlet valves on the gas side but also to the inlet and outlet valves on the cooling and heating oil side. It may be leakage of phthalic anhydride or heating oil but also mechanical malfunctioning.

Switch condenser refers to any device that is capable of exchanging heat and recovering product through the process of desublimation. Switch condensers are typically in a shell-and-horizontal tube type arrangement with an extended surface on the outside of the tubes where the product is condensed. Heat transfer oil is circulated in the tubes. Exemplary switch condensers generally have PAN recoveries of greater than 98.0% and range in capacities of from 10,000 to 60,000 tons/years. Their use has been described in, for example, U.S. Pat. Nos. 4,435,580, 5,214,157, 5,508,443, and 5,869,700. Commercial units are available from RolleChim Impianti S.p.A., Via Della Scienza, 11, 36050 Sovizzo Vicenza, Italy and GEA Luftkühler GmbH, Dorstenerstrasse 18-29, 44651 Herne, Germany.

Sublimation refers to the transition of a compound from the solid to the gas phase with little or no intermediate liquid stage. Sublimation is an endothermic phase transition that occurs at temperatures and pressures below the triple point in a phase diagram. The opposite of sublimation is desublimation or deposition by which gas transforms directly into the solid phase by an exothermic phase change.

Phthalic anhydride may be produced from any of a number of processes: (1) air oxidation of o-xylene in fixed-bed reactors; (2) air oxidation of petroleum or coal tar naphthalene in fixed-bed reactors; (3) fluid bed oxidation of o-xylene; (4) fluid bed oxidation of petroleum or coal tar naphthalene; (5) liquid phase oxidation of o-xylene or naphthalene, or any other suitable process. Thus, producing phthalic anhydride, as recited in the claims, may refer to any number of these processes. The process discussion appearing in more detail below is provided for illustration purposes only.

For example, a general process scheme for the various vapor phase routes is to mix the hydrocarbon feed (in the vapor form) with compressed air and to feed the mixture to fixed-bed reactors which contain tubes packed with catalysts, e.g., vanadium oxide and titanium dioxide coated on an inert, nonporous carrier. When fluid bed reactors are used, the hydrocarbon feed in liquid form is injected directly into the fluidized bed so that the air and the hydrocarbon are mixed in the reactor. The reactors are equipped with means for removing the heat of the oxidation. The heat that is removed is used to generate steam.

In fluid bed reactors, provisions are made to cool the reaction mixture immediately after it leaves the reaction zone. This operation, called “quenching,” is done to stop the reactions and to prevent “after-burning.”

After the gaseous product stream exits either the fixed-bed or fluid bed reactors, it is cooled to cause the phthalic anhydride to condense. This allows separation of the phthalic anhydride from the gas stream. In fixed-bed systems, the phthalic anhydride is typically condensed as a solid. However, a two-stage condensation system may be used to first condense a portion of the phthalic anhydride as a liquid and then to condense the remainder as a solid. In particular, the resultant vapor phase oxidation product is cooled close to the solidification point (131° C.) of PAN and any condensed liquid is usually separated out.

For example, the reaction gases from the reactors enter a gas cooler and a secondary gas cooler before being conveyed to switch condensers. Switch condensers that operate alternately on a cooling cycle and a heating cycle are used to collect the phthalic anhydride as a solid. The solid is then melted for removal from the condensers. The crude phthalic anhydride desublimates from the gas onto the finned tubes of the switch condenser, and the remaining gas mixture exits from the switch condenser. The off-gas is conveyed to thermal or catalytic oxidizers for incineration.

In this process, a number of condensers are connected in parallel so that continuous operation can be maintained by alternately switching from condensing mode to melting mode and recooling mode. After a given amount of PAN has been condensed on the outside surface of a condenser, it is isolated from the process stream and the PAN is melted and collected by raising the temperature of the heat transfer oil. Collection of the molten crude PAN is usually done by gravity draining into a drum before transferring to the final cleanup section. Alternatively, the molten crude PAN is pumped directly from the switch condenser to the final cleanup section. Final cleanup is defined as thermal treatment and distillation.

Normally in a 7 switch condenser configuration, 5 switch condensers are in desublimation mode, one of them in the melting mode and another one in the cooling mode. This is referred to as the 5/2 cycle.

In advanced systems, process controls, such as, for example, software programs, may be applied to help monitor and control the system. Any suitable process control application may be incorporated into the system, such as, for example, an application comprising a distributed control software program or similar process control program. In a class of embodiments, a Honeywell TDC 3000® distributed control release R601 software application automatically controls the various operating modes and the switching steps. The application includes the ability to check the condition of the switching valves in the system to protect downstream catalytic incinerators and to change the temperature of the cooling and heating medium gradually to minimize thermal stress on the equipment. The Honeywell TDC 3000® Release R601 application operates on a High Performance Process Manager (HPM) module, which is part of the Honeywell TDC 3000® process control application, as supplied by Honeywell Process Solutions, Laarderhoogtweg 18, 1101 EA Amsterdam, The Netherlands.

In a class of embodiments, a process for controlling a plurality of switch condensers, comprises:

operating a plurality of switch condensers in an x/y cycle;

detecting at least one change in the plurality of the switch condensers; and

switching the plurality of switch condensers to an x/y−n cycle;

wherein x is the number of switch condensers in the desublimation mode; y is the number of switch condensers in the melting mode and cooling mode; x+y is the sum of the total number of switch condensers; and n is independently a number from 1-20. The n may be a number from 1-15 or 1-10. In the previous embodiments, the process may further comprise switching the plurality of switch condensers to operate in an x−n′/y−n cycle; wherein n′ is independently a number from 1-20. In other embodiments, the process may further comprise switching the plurality of switch condensers to operate in an x+n″/y−n cycle; wherein n″ is independently a number from 1-20.

In another class of embodiments, a process for the recovery of phthalic anhydride, the process comprises:

producing phthalic anhydride;

passing the phthalic anhydride through a plurality of switch condensers operating in a 5/2 cycle;

detecting at least one change in a phthalic anhydride recovery process parameter; and

switching the plurality of switch condensers to operate in a 5/1 cycle. In an embodiment, the process may further comprise switching the plurality of switch condensers to operate in a 4/1 cycle.

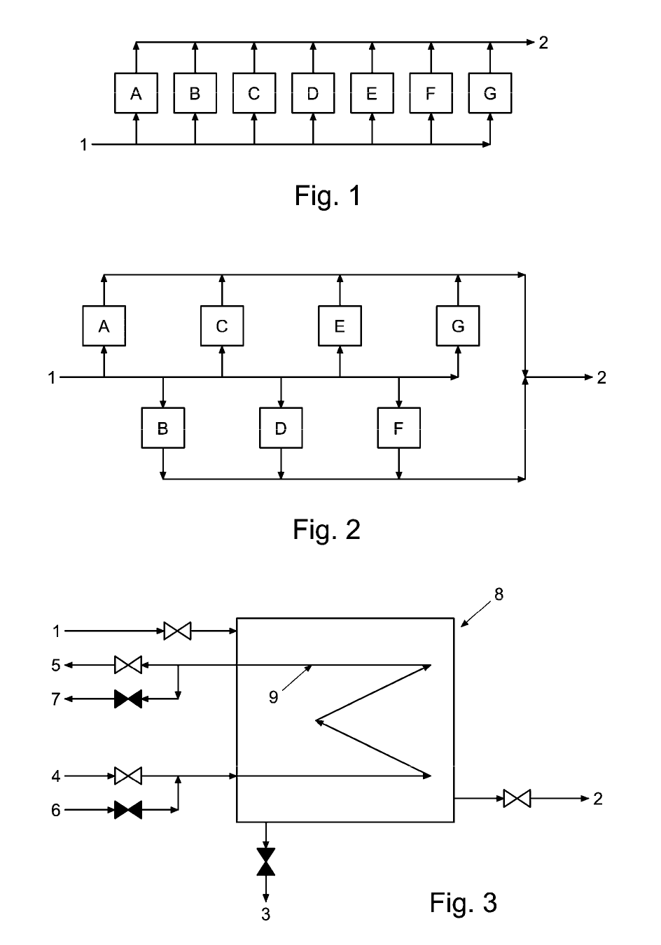

For example, FIG. 1 is a schematic representation of an example of a switch condenser section for the manufacture and recovery of phthalic anhydride from a mixture of air and ortho-xylene or naphthalene. The switch condenser section is part of the oxidation unit which is generally comprised of the following sections: the ortho-xylene or naphthalene evaporator section; the reactor section; the post-reaction section; the gas cooler section; the partial liquid condenser section; and the switch condenser section.

In a class of embodiments, in the switch condenser section, the feed gas (1) from the gas cooler, which is located downstream the reactor section or optionally downstream the post-reactor section, is fed via a single header to a series of 7 parallel switch condensers. In an alternative configuration, the gas from the cooler passes first the partial liquid condenser section before this gas (1) enters the switch condenser section. In the switch condenser, the gaseous phthalic anhydride is condensed as solids on the surface of the switch condenser by a physical process defined as desublimation. The off-gas (2) lean in phthalic anhydride passes through a single header to a downstream located off-gas cleanup section.

FIG. 2 is an alternative schematic representation of an example of a switch condenser section in which the feed gas (1) is fed through a single header to a series of 7 parallel switch condensers but the off-gas (2) leaves the switch condensers through two sub-headers which combine into one single header before passing to the off-gas cleanup section.

FIG. 3 shows an example of a schematic valve arrangement of a switch condenser in the desublimation mode recovering the phthalic anhydride. In several embodiments, the feed gas (1) enters via a valve in the open position of the switch condenser (8), flows along the exterior of the heat exchanger bundle (9), and the off-gas (2) leaves the switch condenser at the bottom side via a valve in the open position. The cooling oil (4) enters the coil via an open valve at the bottom side and the warmer cooling oil (5) leaves the coil via an open valve on the top side to the cooling system for heat removal. In this stage, the valves in the lines of the heating oil supply (6), the colder heating oil return (7), and the molten phthalic anhydride drain (3) are closed.

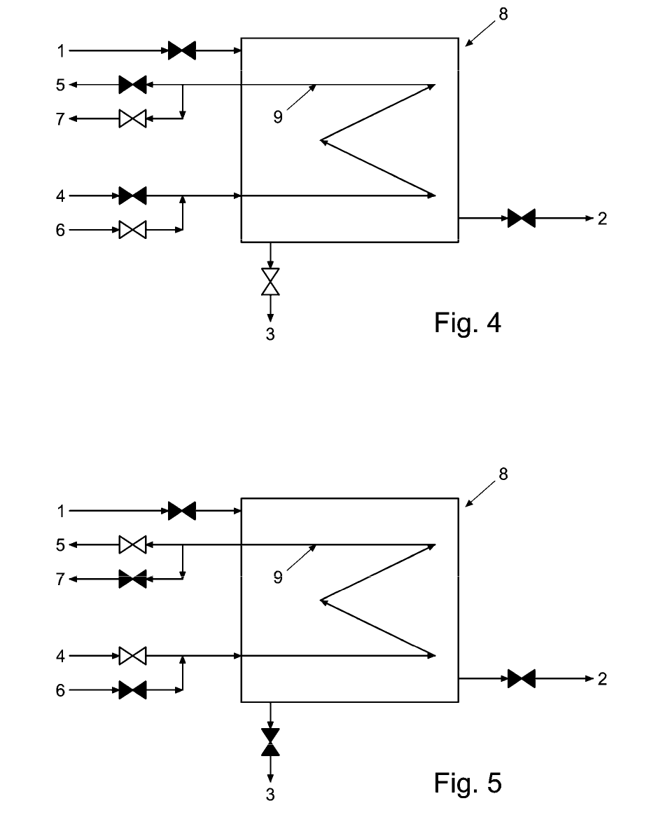

FIG. 4 shows an example of a valve arrangement of a switch condenser in the melting mode to remove the phthalic anhydride from the surface of the heat exchanger bundle and to drain the molten phthalic anhydride from the switch condenser. In this stage, the valves in the lines of the heating oil supply (6), the colder heating oil return (7), and the molten phthalic anhydride drain (3) are opened. The valves of the feed gas (1), the off-gas (2), cooling oil supply (4), and the cooling oil return (5) are closed.

FIG. 5 shows an example of a valve arrangement of a switch condenser in the cooling mode to prepare the switch condenser for the desublimation mode. In this stage, the valves in the lines of the feed gas (1), the off-gas (2), the heating oil supply (6), the colder heating oil return (7), and the molten phthalic anhydride drain (3) are closed. The valves of cooling oil supply (4) and the cooling oil return (5) are opened.

If any of the equipment described above fails or loses efficiency, a switch condenser may have to be taken out of service. For example, in observing at least one change in a phthalic anhydride recovery process parameter, for example, a failure of one of the seven switch condensers in some embodiments, associated equipment and/or associated instrumentation, the PAN production and/or the recovery process must be shutdown. When the process is restarted without the failed switch condenser, it usually must now operate with six switch condensers in a 4/2 cycle mode. Following, four switch condensers are now in desublimation mode, one of them is in the melting mode, and another one in the cooling mode. This configuration as stated above is very uneconomical due to the loss of typically 20% exchanger capacity. This causes a 25% higher gas rate through the switch condensers reducing its efficiency and causing a higher organic load on the downstream thermal or catalytic incinerator. Thus, it also increases the risk of failure of the incinerator catalyst.

In a class of embodiments, in observing at least one change in the phthalic anhydride recovery process parameter, the software changes (preferably, in on-line fashion) the operating mode from the 5/2 cycle into a 5/1 cycle, and optionally, subsequently, into a 4/1 cycle in case of failure of two switch condensers. By this action, equipment, and instrumentation shutdown may be avoided, mitigated, or deferred, while the efficiency of the remaining operating switch condensers is retained to a greater or full extent relative to 4/2 or 3/2 cycle modes. In the 5/1 cycle six switch condenser operation, five switch condensers continue to be in the desublimation mode, whereas one of them will be in the combined melting/cooling mode. In the 4/1 cycle five switch condenser operation 4 switch condensers continue to be in the desublimation mode, whereas one of them will be in the combined melting/cooling mode.

In another class of embodiments, in observing at least one change in the phthalic anhydride recovery process parameter, for example, upon failure of one or more switch condensers, one could reduce the gas flow through the switch condenser section by the ratio of the failed condenser(s) to the total number of condensers used in recovery service. This is followed by taking the failed condenser(s) offline and isolating them for repair. The reduction in gas rate will only be required if the available number of condensers and the total area used for recovery of the phthalic anhydride is constrained by the gas flow and maximum allowable pressure drop. It is however conceivable that the gas flow rate is not limiting but the phthalic anhydride accumulation capacity of the switch condensers is the limiting factor. In such an event, the concentration of the phthalic anhydride in the gas stream has to be reduced by reducing the o-xylene or naphthalene feed concentration in the gas to the upstream reactor. Both the reduction of the gas flow and/or the phthalic anhydride concentration causes a reduction of the productivity of the production unit.

In one more class of embodiments, in observing at least one change in the phthalic anhydride recovery process parameter, one could build one or more additional switch condensers as an installed spare unit to compensate for the failure of one or more switch condensers. In case of failure, the spare unit is taken into service and followed by decommissioning the failed unit. An alternative solution can be to build bigger switch condensers with a larger internal area to compensate for the loss of surface area in case of failure of one or more of the switch condensers.

In a further class of embodiments, in observing at least one change in the phthalic anhydride recovery process parameter, upon prevention of failure of valves and instrumentation, it is possible to duplicate those valves and instrumentation, to temporarily operate with manual control, or to install valves and instrumentation with a higher class of reliability or better materials. This also applies to the materials of the switch condensers, which are normally made out of low cost carbon steel, but can be fabricated from more corrosion resistant stainless steel material.

In all these cases a higher investment, higher operating cost, higher manpower requirement, and/or reduced production will lead to a reduced efficiency of the phthalic anhydride production and recovery.

Following, with minimal process disruption, the crude phthalic anhydride is then usually heat-treated in a decomposer, but in some cases chemical treatment is also used. The heat treatment is carried out by holding the molten crude phthalic anhydride at an elevated temperature (approximately 250-280° C.) for a period usually of 12-36 hours and under a small vacuum. The purpose of the heat treatment is to dehydrate any phthalic acid in the crude to phthalic anhydride, to boil off materials such as water, and to form either condensation or volatile products with the other impurities so that the subsequent product purification by distillation is simplified.

After distillation, the pure molten product may be solidified, flaked, bagged, and stored in a warehouse. Alternatively, the molten product may be pumped into large storage tanks and then into road tankers or railway tank cars for shipment.

In another example, one system for producing phthalic anhydride from o-xylene by air oxidation proceeds as follows. The process is initiated by pumping o-xylene from a storage tank via a pump through a filter and o-xylene preheater, where it is heated almost to the vaporization point. Air is passed through an air filter and silencers, compressed in an air compressor, and heated in an air preheater before being mixed with the hot liquid o-xylene. The hot liquid o-xylene is injected into the hot air stream via spray nozzles and vaporized. The vaporized air-xylene mixture passes through knock-out drums. The treated air-xylene mixture then enters fixed-bed reactors. The reactors each contain vertical tubes packed with various catalysts. The heat of reaction is removed by molten salt circulating in the reactor shell via a salt bath cooler and agitator systems. The salt is cooled by steam coils that produce steam to be used throughout other parts of the process.

The reaction gas is typically composed of nitrogen, oxygen, water, carbon dioxide, carbon monoxide, argon, phthalic anhydride, maleic anhydride, maleic acid, o-toluic acid, and partial oxidation products, for example, phthalide, etc.

The reaction gases from the reactors enter a gas cooler and a secondary gas cooler before being conveyed to switch condensers. The crude phthalic anhydride desublimates onto the tubes of the switch condenser, and the remaining gas mixture exits from the switch condenser. The off-gas is conveyed to thermal oxidizers for incineration. Thermal incineration of the gas is done by raising the temperature of the effluent gas to temperatures of from 700° C. to 1000° C. for several seconds. This oxidizes the remaining organic materials. The switch condensers are cooled by passing low viscosity oil through their tubes. The cold oil is cooled in a cold oil system by cooling water or by air to 50-70° C.

During the heating cycle, hot oil of typically 160-200° C. is circulated through the tubes of the switch condenser to melt the crude phthalic anhydride plated thereon. The liquid anhydride flows into crude product surge vessels. The liquid anhydride is thereafter pumped to a storage tank.

The crude phthalic anhydride liquid is delivered via pumps and a filter and to a preheater where it is heated to approximately 260° C. The heated crude phthalic anhydride is conveyed continuously through decomposers. The residence time in each decomposer is about 6-12 hours. Decomposers operate under a slight vacuum (about 700 mm Hg absolute) and high temperatures (e.g., 260° C.) to convert the small amount of phthalic acid that is present to phthalic anhydride. Additionally, most of the maleic anhydride in the crude is removed by evaporation or chemical reaction. Evaporated impurities especially water are removed via a condenser and ejector jets. Condensed phthalic anhydride is returned to the decomposers from the condenser.

Purified phthalic anhydride is pumped from the decomposers to a light ends column or a fractionation column. The column may include a reflux condenser and ejector jets. Low-boiling by-products, e.g., maleic anhydride and benzoic acid, along with a small amount of phthalic anhydride are removed at the top of the column. Low pressure steam is generated in the reflux condenser. Crude phthalic anhydride from the bottom of the column is fed via a pump to either a reboiler where it is returned to the column or a second fractionation column.

Pure phthalic anhydride is removed from the top of the column. Along with the tailings, phthalic anhydride is continuously removed from the bottom of the column and sent to a reboiler in order to maintain the temperature of the column. The column includes a reflux condenser and ejector jets. The pure phthalic anhydride from the top of the column is sent to phthalic anhydride run-down tanks and eventually stored in storage tanks.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

### Example 1

A phthalic anhydride production facility is equipped with seven switch condensers operating according to a configuration as shown in FIG. 1 or 2: five operate in the desublimation mode, one in the melting mode, and one in the cooling mode. This is generally referred to as the basic 5/2 cycle mode. The desublimation, melting, and cooldown proceed in a pre-programmed fashion by the TDC-3000® process control application in 14 steps of respectively 1.5 and 37 minutes with a total cycle time of almost 270 min as shown in TABLE 1. The short 1.5 min steps are to switch from one mode to another mode, the long 37 min steps are to perform the recovery process.

Following a period during which the switch condenser operates in the desublimation mode as illustrated in FIG. 3, the gas inlet and outlet valves are first closed to start the transition to the melting mode as illustrated in FIG. 4. This is followed by closing the cooling oil inlet valve and simultaneously opening the heating oil inlet valve, and with a delay closing the cooling oil outlet valve and opening the heating oil outlet valve. Upon temperature increase to above the melting point of the phthalic anhydride, the melting starts and the drain valve is opened to remove the phthalic anhydride from the switch condenser. The change of the cooling oil to the heating oil is executed on temperature control to prevent a too fast temperature change of the switch condenser as this otherwise may damage the equipment. During the transition, the application monitors the actual position of the valves relative to the pre-programmed positions and gives an alarm in case of a deviation.

Upon completion of the melting mode as illustrated in FIG. 4, the transition to the cooling mode as illustrated in FIG. 5 is made by closing the heating oil inlet valve and the drain valve, while simultaneously the cooling oil inlet valve is opened. This is again followed by the closing and opening of the oil return valves. The change of the heating to the cooling oil is again executed on temperature control. Following the cooling mode as illustrated in FIG. 5, the switch condenser is returned to the desublimation mode as illustrated in FIG. 3. This is done by opening the gas outlet valve and by stepwise opening the gas inlet valve to compensate for the difference in pressure drop between a clean/empty switch condenser and ones being partially loaded, for example, with phthalic anhydride.

TABLE 1
Basic cycle “5/2” mode

| | Time | | | | | | | |
|---|---|---|---|---|---|---|---|---|
| Step | [min] | A | B | C | D | E | F | G |
| 1 | 1.5 | D | M | M | D | D | D | D |
| 2 | 37 | D | C | M | D | D | D | D |
| 3 | 1.5 | D | D | M | M | D | D | D |
| 4 | 37 | D | D | C | M | D | D | D |
| 5 | 1.5 | D | D | D | M | M | D | D |
| 6 | 37 | D | D | D | C | M | D | D |
| 7 | 1.5 | D | D | D | D | M | M | D |
| 8 | 37 | D | D | D | D | C | M | D |
| 9 | 1.5 | D | D | D | D | D | M | M |
| 10 | 37 | D | D | D | D | D | C | M |
| 11 | 1.5 | M | D | D | D | D | D | M |
| 12 | 37 | M | D | D | D | D | D | C |
| 13 | 1.5 | M | M | D | D | D | D | D |
| 14 | 37 | C | M | D | D | D | D | D |

| | |
|---|---|
| 269.5 | Total cycle time |

Legend: M = Melting, C = Cooldown, D = Desublimation

### Example 2 (Comparative)

In the event that the performance of a switch condenser starts deteriorating, a leak develops, or the instrumentation becomes malfunctioning, it is convenient and typically practiced to take the condenser off-line and switch to the 4/2 cycle mode as shown in TABLE 2. For instance, switch condenser A may be taken out of service in step 11 of the program. Simultaneously, the gas flow through the facility has to be reduced by 20% to compensate for the loss of one out five operating condensers because the condensers are only 154 min on-line versus 192.5 min. In this case, the completion of the melting step and the cooling step of switch condenser G is changed to step 13 and 14 of the basic cycle.

TABLE 2
Cycle “4/2” mode for switch condenser A out of service

| | Time | | | | | | | |
|---|---|---|---|---|---|---|---|---|
| Step | [min] | A | B | C | D | E | F | G |
| 1 | 1.5 | — | M | M | D | D | D | D |
| 2 | 37 | — | C | M | D | D | D | D |
| 3 | 1.5 | — | D | M | M | D | D | D |
| 4 | 37 | — | D | C | M | D | D | D |
| 5 | 1.5 | — | D | D | M | M | D | D |
| 6 | 37 | — | D | D | C | M | D | D |
| 7 | 1.5 | — | D | D | D | M | M | D |
| 8 | 37 | — | D | D | D | C | M | D |
| 9 | 1.5 | — | D | D | D | D | M | M |
| 10 | 37 | — | D | D | D | D | C | M |
| 11 | 1.5 | — | — | — | — | — | — | — |
| 12 | 37 | — | — | — | — | — | — | — |
| 13 | 1.5 | — | M | D | D | D | D | M |
| 14 | 37 | — | M | D | D | D | D | C |

| | |
|---|---|
| 231 | Total cycle time |

Legend: M = Melting, C = Cooldown, D = Desublimation

### Example 3

In the event that the performance of a switch condenser starts deteriorating, a leak develops, or the instrumentation becomes malfunctioning, the process control application is first switched to the 6/1 cycle mode by changing the timers of the odd and even steps and adapting the melting and cooling steps to the new mode as shown in TABLE 3. In this case, the software change is made after step 14 of the 5/2 cycle by advancing for switch condenser B the step 2 initially to step 1, and subsequently to step 14. All other melting and cooling steps are altered as well in such a way that now 6 switch condensers are in operating desublimation mode.

TABLE 3
Cycle “6/1” mode

| | Time | | | | | | | |
|---|---|---|---|---|---|---|---|---|
| Step | [min] | A | B | C | D | E | F | G |
| 1 | 30 | D | C | M | D | D | D | D |
| 2 | 12 | D | D | C | D | D | D | D |
| 3 | 30 | D | D | D | M | D | D | D |
| 4 | 12 | D | D | D | C | D | D | D |
| 5 | 30 | D | D | D | D | M | D | D |
| 6 | 12 | D | D | D | D | C | D | D |
| 7 | 30 | D | D | D | D | D | M | D |
| 8 | 12 | D | D | D | D | D | C | D |
| 9 | 30 | D | D | D | D | D | D | M |
| 10 | 12 | D | D | D | D | D | D | C |
| 11 | 30 | M | D | D | D | D | D | D |
| 12 | 12 | C | D | D | D | D | D | D |
| 13 | 30 | D | M | D | D | D | D | D |
| 14 | 12 | D | C | D | D | D | D | D |

| | |
|---|---|
| 294 | Total cycle time |

Legend: M = Melting, C = Cooldown, D = Desublimation

After rearranging the timers and sequences, it is now conveniently possible to take the switch condenser involved off-line. In this example, switch condenser A is taken off-line in step 11 as shown in TABLE 4 for the 5/1 cycle mode. Following this cycle mode change, the gas flow remains unchanged or substantially the same.

TABLE 4
Cycle “5/1” mode

| | Time | | | | | | | |
|---|---|---|---|---|---|---|---|---|
| Step | [min] | A | B | C | D | E | F | G |
| 1 | 30 | — | D | M | D | D | D | D |
| 2 | 12 | — | D | C | D | D | D | D |
| 3 | 30 | — | D | D | M | D | D | D |
| 4 | 12 | — | D | D | C | D | D | D |
| 5 | 30 | — | D | D | D | M | D | D |
| 6 | 12 | — | D | D | D | C | D | D |
| 7 | 30 | — | D | D | D | D | M | D |
| 8 | 12 | — | D | D | D | D | C | D |
| 9 | 30 | — | D | D | D | D | D | M |
| 10 | 12 | — | D | D | D | D | D | C |
| 11 | 30 | — | — | — | — | — | — | — |
| 12 | 12 | — | — | — | — | — | — | — |
| 13 | 30 | — | M | D | D | D | D | D |
| 14 | 12 | — | C | D | D | D | D | D |

| | |
|---|---|
| 252 | Total cycle time |

Legend: M = Melting, C = Cooldown, D = Desublimation

In the event that switch condenser A becomes available for service again, it is possible to put this condenser into operation after step 10 of TABLE 4 and operate in the 6/1 cycle mode according to the scheme as presented in TABLE 3 before transitioning back to the 5/2 cycle mode as represented in TABLE 1.

### Example 4

In the event that another switch condenser fails during the 5/1 cycle mode, it is possible to switch to the 4/1 cycle mode according to TABLE 5 by for instance taking switch condenser B out of service.

TABLE 5
Cycle “4/1” mode

| | Time | | | | | | | |
|---|---|---|---|---|---|---|---|---|
| Step | [min] | A | B | C | D | E | F | G |
| 1 | 30 | — | — | M | D | D | D | D |
| 2 | 12 | — | — | C | D | D | D | D |
| 3 | 30 | — | — | D | M | D | D | D |
| 4 | 12 | — | — | D | C | D | D | D |
| 5 | 30 | — | — | D | D | M | D | D |
| 6 | 12 | — | — | D | D | C | D | D |
| 7 | 30 | — | — | D | D | D | M | D |
| 8 | 12 | — | — | D | D | D | C | D |
| 9 | 30 | — | — | D | D | D | D | M |
| 10 | 12 | — | — | D | D | D | D | C |
| 11 | 30 | — | — | — | — | — | — | — |
| 12 | 12 | — | — | — | — | — | — | — |
| 13 | 30 | — | — | — | — | — | — | — |
| 14 | 12 | — | — | — | — | — | — | — |

| | |
|---|---|
| 210 | Total cycle time |

Legend: M = Melting, C = Cooldown, D = Desublimation

Commissioning of a switch condenser is possible by first going from the 4/1 cycle mode to the 5/1 cycle mode, and for another one, to the 6/1 cycle mode, which may be altered into the 5/2 cycle mode.

Unless otherwise specified, essentially, substantially, or the like relate to a deviation of no more than 15%, alternatively, no more than 10%, and alternatively, no more than 5%.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

1. A continuous process for controlling a plurality of switch condensers, the process comprising:
operating a plurality of switch condensers in an x/y cycle;
detecting at least one change in the plurality of the switch condensers; and switching the plurality of switch condensers to an x/y−n cycle;
wherein x is the number of switch condensers in the desublimation mode; y is the number of switch condensers in the melting mode and cooling mode; x+y is the sum of the total number of switch condensers; and n is independently a number from 1-20.

2. The process of claim 1, wherein n is a number from 1-15.

3. The process of claim 1, wherein n is a number from 1-10.

4. The process of claim 1, further comprising switching the plurality of switch condensers to operate in an x−n′/y−n cycle; wherein n′ is independently a number from 1-20.

5. The process of claim 1, further comprising switching the plurality of switch condensers to operate in an x+n″/y−n cycle; wherein n″ is independently a number from 1-20.

6. The process of claim 1, wherein the switching is controlled by a process control application.

7. The process of claim 6, wherein the process control application comprises a distributed control software program.

8. The process of claim 6, wherein the process control application comprises at least one of the abilities to control the operating modes, to monitor the condition of the switching valves, to regulate the temperature of the switch condensers, and any combination thereof.

9. The process of claim 1, wherein after the switching, the gas rate through the switch condensers remains substantially the same.

10. The process of claim 1, wherein after the switching, the gas rate through the switch condensers is increased by no more than 10%.

11. The process of claim 1, wherein after the switching, the gas rate through the switch condensers is increased by no more than 5%.

12. The process of claim 1, wherein the loss of heat exchanger capacity of the plurality of the switch condensers after switching cycles is 15% or less.

13. The process of claim 1, wherein the loss of heat exchanger capacity of the plurality of the switch condensers after switching cycles is 10% or less.

14. The process of claim 1, wherein the loss of heat exchanger capacity of the plurality of the switch condensers after switching cycles is 5% or less.

15. A continuous process for the recovery of phthalic anhydride, the process comprising:
producing phthalic anhydride; passing the phthalic anhydride through a plurality of switch condensers operating in a 5/2 cycle;
detecting at least one change in a phthalic anhydride recovery process parameter; and
switching the plurality of switch condensers to operate in a 5/1 cycle.

16. The process of claim 15, further comprising switching the plurality of switch condensers to operate in a 4/1 cycle.

17. The process of claim 15, wherein the at least one change comprises a switch condenser failure.

18. The process of claim 1, wherein the loss of heat exchanger capacity of the plurality of the switch condensers after switching cycles is 15% or less.

19. The process of claim 1, wherein the loss of heat exchanger capacity of the plurality of the switch condensers after switching cycles is 10% or less.

20. The process of claim 1, wherein the loss of heat exchanger capacity of the plurality of the switch condensers after switching cycles is 5% or less.

21. The process of claim 15, wherein the switching is controlled by a process control application.

22. The process of claim 21, wherein the process control application comprises a distributed control software program.

23. The process of claim 21, wherein the process control application comprises at least one of the abilities to control the operating modes, to monitor the condition of the switching valves, to regulate the temperature of the switch condensers, and any combination thereof.

24. The process of claim 15, wherein after the switching, the gas rate through the switch condensers remains substantially the same.

25. The process of claim 15, wherein after the switching, the gas rate through the switch condensers is increased by no more than 10%.

26. The process of claim 15, wherein after the switching, the gas rate through the switch condensers is increased by no more than 5%.
